(19) United States
(12) Patent Application Publication
(10) Pub. No.: US 2025/0153451 A1
(43) Pub. Date: May 15, 2025

(54) PRESS TOOL SYSTEMS AND METHODS

(71) Applicant: Tiger Tool International Incorporated, Abbotsford (CA)

(72) Inventor: Michael Andrews, Bellingham, WA (US)

(73) Assignee: Tiger Tool International Incorporated, Abbotsford, BC (CA)

(21) Appl. No.: 18/485,986

(22) Filed: Oct. 12, 2023

(51) Int. Cl. B30B 1/22; B25B 13/06

(52) U.S. Cl. CPC B30B 1/22; B25B 13/06

(57) ABSTRACT

A press tool for using a plurality of socket drives each defining a square drive cavity, a socket cavity, and a socket perimeter surface extending around the socket cavity to displace a first part relative to a second part, the press tool comprising a drive system, a first drive projection, and a first friction member. The first drive projection is adapted to be received at least partly within the square drive cavity of a first selected socket drive of the plurality of socket drives. The first friction member is arranged between the first drive projection and the square drive cavity of the first selected socket drive to enhance friction between the first drive projection and the first selected drive socket.

### TECHNICAL FIELD

The present invention relates to assembly and disassembly of universal joints (U-joints) and, more specifically, to press tool systems and methods that can be easily configured to accommodate universal joints of different sizes and configurations.

### BACKGROUND

Universal joins, or U-joints, are commonly used in mechanical systems. U-joints typically require repair and maintenance after a period of use. The repair and maintenance of a U-joint typically require that the U-joint be disassembled, worn parts repaired and/or replaced, and then reassembly of the U-joint.

In particular, a typical U-joint comprises a shaft defining arms, a yoke, a cross, and a bushing that connects the arms to the cross. Different U-joints employ different bushings of different sizes and dimensions. Disassembly and reassembly of a U-joint typically requires removal and replacement of the bushing. The bushing must be forced or pressed out of the space between the arms and the cross. To remove the bushing, force must be applied to the bushing while the arms and cross are held in place and also while minimizing damage to the components of the U-joint. An example press tool is described in the Applicant's U.S. patent Ser. No. 10/744,627.

The need exists for improved press tools for assembling and disassembling a U-joint.

### SUMMARY

The present invention may be embodied as a press tool for using a plurality of socket drives each defining a square drive cavity, a socket cavity, and a socket perimeter surface extending around the socket cavity to displace a first part relative to a second part, the press tool comprising a drive system, a first drive projection, and a first friction member. The first drive projection is adapted to be received at least partly within the square drive cavity of a first selected socket drive of the plurality of socket drives. The first friction member is arranged between the first drive projection and the square drive cavity of the first selected socket drive to enhance friction between the first drive projection and the first selected drive socket.

### BRIEF DESCRIPTION OF THE DRAWINGS

FIG. 1 is a top plan, partially exploded view of a first example press tool of the present invention;

FIG. 2 is a side elevation view of a first example linear drive system that may be used by the first example press tool;

FIG. 3 is a section view taken along lines 3-3 in FIG. 2;

FIG. 4 is a top plan view the first example press tool in a pre-assembled configuration;

FIG. 5 perspective view of first and second example drive heads of the first example press tool;

FIG. 6 is a section view taken along lines 6-6 in FIG. 4;

FIG. 7 is a top plan view depicting arrangement of the first example press tool in an assembled configuration to disassemble an example universal joint;

FIG. 8 is a side elevation, partially exploded view of a second example press tool of the present invention;

FIG. 9 is a top plan view illustrating the second example press tool in an assembled configuration;

FIG. 10 is a top plan view illustrating a first step in a method of using the second example press tool to disassemble an example universal joint;

FIG. 11 is a top plan view illustrating a second step in a method of using the second example press tool to disassemble an example universal joint;

FIG. 12 is a side elevation, partially exploded view of a third example press tool of the present invention;

FIG. 13 is a side elevation view of the third example press tool in an assembled configuration;

FIG. 14 is a side elevation, partially exploded view of a fourth example press tool of the present invention;

FIG. 15 is a side elevation view of the fourth example press tool in an assembled configuration;

FIG. 16 is a side elevation, partially exploded view of a fifth example press tool of the present invention;

FIG. 17 is a side elevation view of the fifth example press tool in an assembled configuration;

FIGS. 18A and 18B are side and end elevation views of a first alternative example connecting member that may be used as part of a press tool of the present invention;

FIG. 19 is a side elevation view of a first alternative example connecting assembly that may be used as part of a press tool of the present invention;

FIGS. 20A and 20B are side and end elevation views of a second alternative example connecting member that may be used as part of a press tool of the present invention;

FIG. 21 is a side and end elevation view of a second alternative example connecting assembly that may be used as part of a press tool of the present invention;

FIGS. 22A and 22B are side and end elevation views of a third alternative example connecting member that may be used as part of a press tool of the present invention;

FIG. 23 is a side elevation view of a third alternative example connecting assembly that may be used as part of a press tool of the present invention;

FIGS. 24A and 24B are side and end elevation views of a fourth alternative example connecting member that may be used as part of a press tool of the present invention; and

FIG. 25 is a top plan view of a fourth alternative example connecting assembly that may be used as part of a press tool of the present invention.

### DETAILED DESCRIPTION

The principles of the present invention may be embodied in different physical forms, and several example press tools of the present invention will be described below.

### I. First Example U-Joint Tool

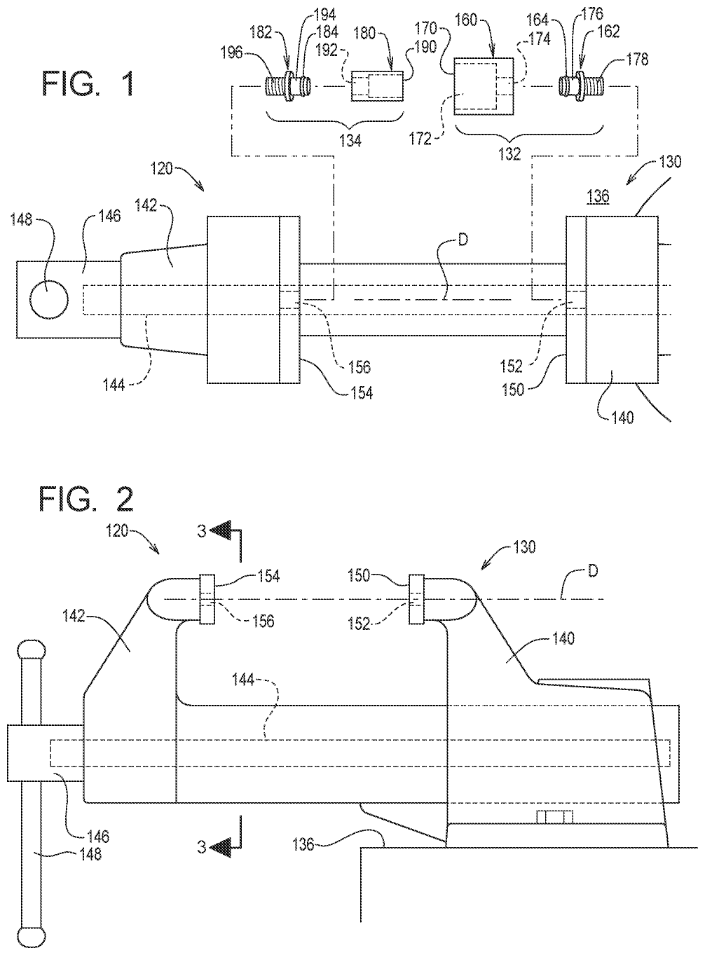

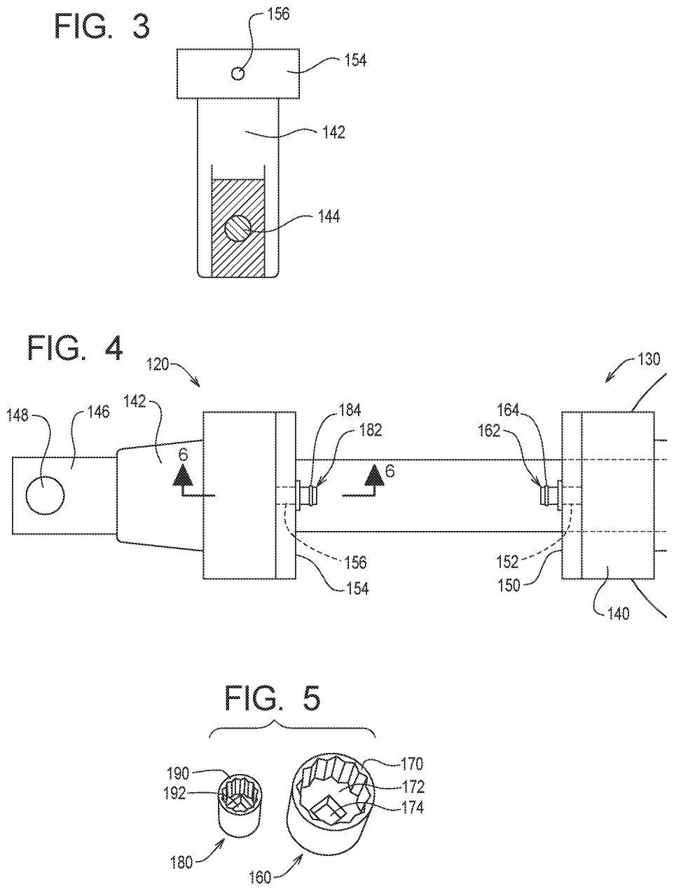

Referring initially to FIGS. 1-7 of the drawing, depicted therein is a first example press tool 120 constructed in accordance with, and embodying, the principles of the present invention.

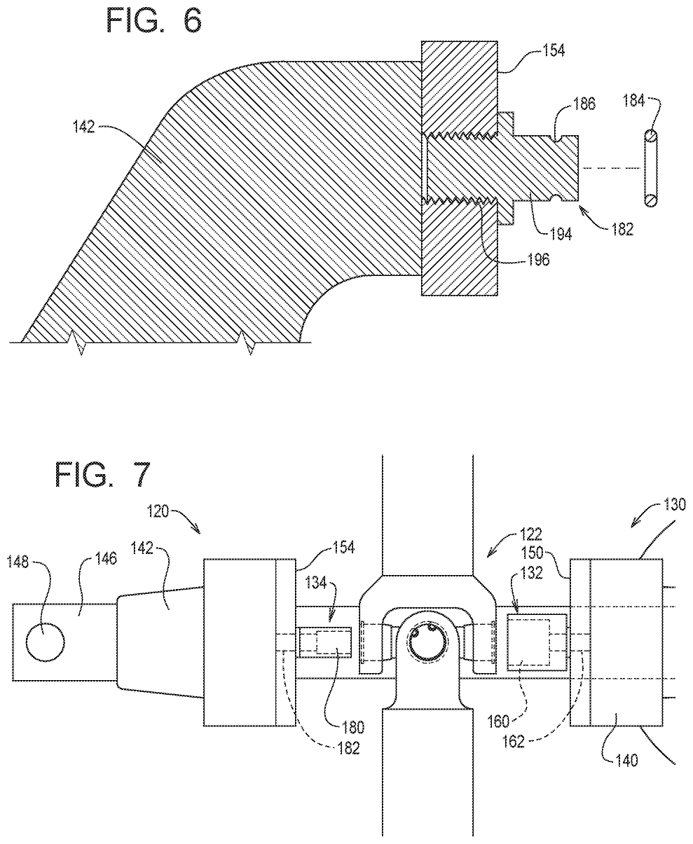

FIG. 7 illustrates the use of the first example press tool 120 to disassemble an example universal joint 122. The universal joint 122 is or may be conventional, is shown and described herein by way of example only and does not per se form a part of the first example press tool 120 of the present invention. The example universal joint 122 will thus be described herein only to the extent necessary for a complete understanding of the construction and operation of the example press tools of the present invention. In addition, universal joints come in a variety of sizes and configurations, and the first example press tool 120 may be reconfigured to accommodate different sizes and configurations of universal joints as will be described in further detail below. The term “bushing” may be used herein as a shorthand to refer to an assembly that operatively connects the arm of a universal joint to a cross of a universal joint. A “bushing” as that term is used herein typically comprising a bushing, roller bearing, seal(s), and/or seal retainer(s), but the use of the term “bushing” does not indicate that the present invention is to be used to disassemble or reassemble a particular type of universal joint.

FIGS. 1-7 illustrate that the first example press tool 120 comprises a linear drive system 130, a first drive assembly 132, and a second drive assembly 134. The first example press tool 120 is adapted to be supported on a work surface 136.

The example linear drive system 130 comprises a stationary member 140, a movable member 142, a threaded member 144, a collar 146, and a handle 148. The stationary member 140 defines a stationary engaging surface 150 in which is formed a stationary connecting portion 152. The movable member 142 defines a movable engaging surface 154 that defines a movable connecting portion 156. A drive axis D extends through the stationary and movable connecting portions 152 and 156. The movable member 142 is supported for linear movement relative to the stationary member 140. The threaded member 144 extends through the movable member 142 and engages the stationary member 140 such that axial rotation of the threaded member 144 causes linear movement of the threaded member 144 relative to the stationary member 140. The collar 146 is secured to the threaded member 144 and engages the movable member 142 such that linear movement of the threaded member 144 causes linear movement of the movable member 142 relative to the stationary member 140. The handle 148 facilitates axial rotation of the threaded member 144. As will be apparent from the following discussion, the example linear drive system 130 may be constructed and operated in manner similar to that of a conventional bench vice.

The first drive assembly 132 comprises a first drive head 160 and a first drive base 162. The example first drive base 162 is combined with an O-ring 164 to form a first drive base assembly. The first drive head 160 defines a first head surface 170, a first drive head cavity 172, and a first connecting portion 174. The first drive base 162 defines second and third connecting portions 176 and 178. The second drive assembly 134 comprises a second drive head 180 and a second drive base 182. The example second drive base 182 is combined with an O-ring 184 to form a second drive base assembly. The second drive head 180 defines a second head surface 190 and a fourth connecting portion 192. The second drive base 182 defines fifth and sixth connecting portions 194 and 196. Referring for a moment to the exploded section view of FIG. 6, it can be seen that the example fifth connecting portion 194 is a cylindrical post and a retaining groove 186 is formed in the fifth connecting portion 194 to inhibit inadvertent removal of the O-ring 184 from the second drive base 182 during normal use of the second drive assembly 134. The second connecting portion 176 defined by the first drive base 162 may also be formed by a cylindrical post, and a similar retaining grove (not visible in FIGS. 1 and 4, may be formed on the second connecting portion 176 to inhibit inadvertent removal of the O-ring 164 from the first drive base 162 during normal use of the first drive assembly 132.

In use, the stationary member 140 is arranged on, and may be secured to, the work surface 136. Using the first, second, and third connecting portions 174, 176, and 178, the first drive assembly 132 is detachably attached to the stationary engaging surface 150. Using the fourth, fifth, and sixth connecting portions 192, 194, and 196, the second drive assembly 134 is detachably attached to the movable engaging surface 154.

More specifically, the first and second connecting portions 174 and 176 engage each other to detachably attached first drive head 160 to the first drive base 162. The third connecting portion 178 of the first drive assembly 132 is sized and dimensioned to be received within a cavity defining the stationary connecting portion 152 to detachably attach the first drive base 162 to the stationary member 140. The fourth and fifth connecting portions 192 and 194 engage each other to detachably attach the second drive head 180 to the second drive base 182. The third connecting portion 196 of the second drive assembly 134 is sized and dimensioned to be received within the movable connecting portion 156 to detachably attach the second drive base 182 to the movable member 142.

The O-rings 164 and 184 are sized, dimensioned, configured, and arranged to enhance a friction fit between the first drive base 162 and the first connecting portion 174 and between the second drive base 182 and the fourth connecting portion 192, respectively, when the first drive assembly 132 is in an assembled configuration. The O-rings 164 and 184 thus hold the drive heads 160 and 180 in place when the first and second drive assemblies 132 and 134 are in the assembled configuration to prevent inadvertent removal of the drive heads 160 and 180 prior to use of the first example press tool 120.

The example first drive head 160 and second drive head 180 may be formed by standard socket drives for a socket wrench. A set of relatively inexpensive, off-the-shelf socket drives allows the user to adapt the first example press tool 120 to accommodate a wide variety of sizes, shapes, and configurations of universal joints in addition to the example universal joint 122 by selecting an appropriate socket drive as the receiving and drive heads 160 and 180.

Assembled as described above, the first example press tool 120 may then be used to disassemble a universal joint such as the example universal joint 122 depicted in FIG. 7. By reversing this process, the first example press tool 120 may also be used to reassemble the universal joint 122.

### II. Second Example U-Joint Tool

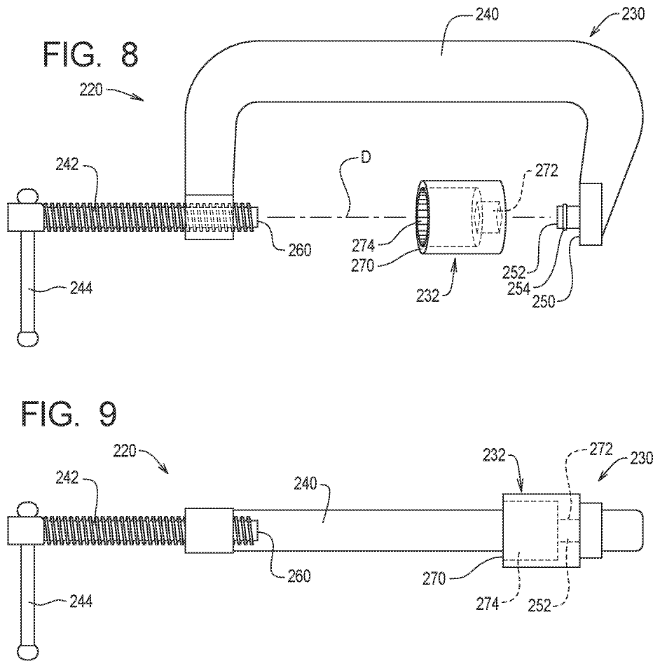

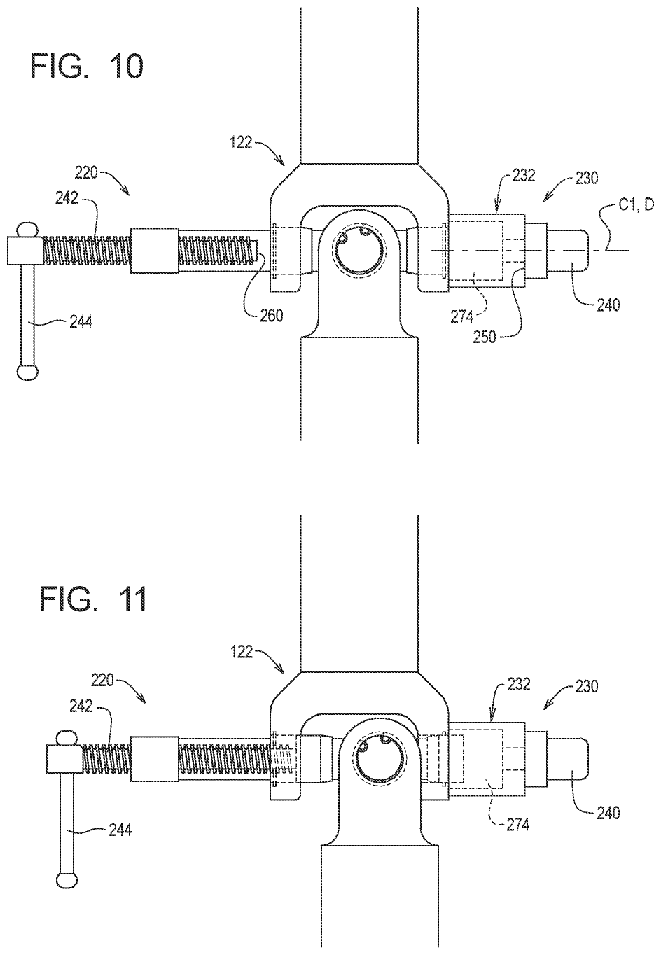

Referring now to FIGS. 8 and 9 of the drawing, depicted therein is a second example press tool 220 constructed in accordance with, and embodying, the principles of the present invention. The second example press tool 220 comprises a linear drive system 230 and a receiving member 232. The second example press tool 220 may be used to disassemble the example universal joint 122 as shown in FIGS. 10 and 11.

The example linear drive system 230 comprises a base member 240, a threaded member 242, and a handle 244. Except for as noted below, the example linear drive system 230 may be constructed and operated in manner similar to that of a conventional C-clamp and is typically not directly supported by a work surface. The base member 240 defines a base surface 250, a first connecting portion 252, and an O-ring 254. The example first connecting portion 252 is integrally formed with the base member 240 but may be detachably attached thereto.

The example threaded member 242 defines a drive surface 260. A drive axis D extends through the first connecting portion 252 and the drive surface 260. The threaded member 242 engages the base member 240 such that axial rotation of the threaded member 242 causes linear movement of the threaded member 242 relative to the base member 240. The handle 244 is arranged to facilitate axial rotation of the threaded member 242.

The receiving member 232 defines an engaging surface 270, a second connecting portion 272, and a receiving cavity 274. The second connecting portion 272 is configured to engage the first connecting portion 252 to detachably attach the receiving member to the base surface 250 of the base member 240.

In use, the receiving member 232 is detachably attached to the base member 240 using the first and second connecting portions 252 and 272. In the example linear drive system 230, the first connecting portion 252 is formed by a cylindrical post and the second connecting portion 272 is formed by a female square drive. The O-ring 254 is sized, dimensioned, configured, and arranged to enhance a friction fit between the first connecting portion 252 and the second connecting portion 272.

In this example, the example receiving member 232 may thus be formed by a standard socket drive selected from a set of standard socket drives configured for use as a socket wrench. Accordingly, a set of relatively inexpensive, off-the-shelf socket drives allows the user to adapt the second example press tool 220 to accommodate a wide variety of sizes, shapes, and configurations of universal joints in addition to the example universal joint 122. The O-ring 254 thus hold standard socket drives used as the receiving member 232 in place when the example press tool 220 is in the assembled configuration to prevent inadvertent removal of the receiving member 232.

Assembled as described above, the second example press tool 220 may then be used to disassemble and/or reassemble a universal joint such as the example universal joint 122. The threaded member 242 is initially spaced from the base surface 250 and receiving member 232 detachably attached thereto a distance sufficient to allow the press tool 220 to be arranged such that the universal joint 122 is arranged in a desired orientation relative to the press tool 220.

The handle 244 is then operated to rotate the threaded member 242 in the opposite direction such that the receiving member 232 and drive surface 260 disengage from the universal joint 122. The second example press tool 220 may thus be used to disassemble a universal joint such as the example universal joint 122. By reversing the disassembly process, the second example press tool 220 may also be used to reassemble the universal joint 122.

### III. Third Example U-Joint Tool

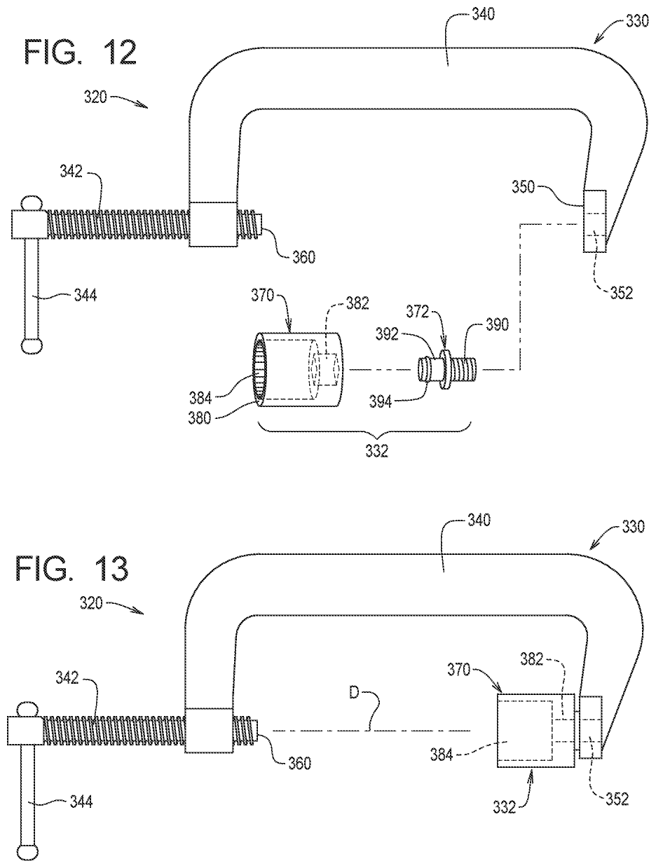

Referring now to FIGS. 12 and 13 of the drawing, depicted therein is a third example press tool 320 constructed in accordance with, and embodying, the principles of the present invention. FIGS. 12 and 13 illustrate that the third example press tool 320 comprises a linear drive system 330 and a receiving assembly 332.

The example linear drive system 330 comprises a base member 340, a threaded member 342, and a handle 344. Except for as noted below, the example linear drive system 330 may be constructed and operated in manner similar to that of a conventional C-clamp and is typically not directly supported by a work surface. The example base member 340 defines a base surface 350 and a first connecting portion 352. The example first connecting portion 352 is integrally formed with the base member 340 but may be detachably attached thereto. The threaded member 342 defines a drive surface 360. A drive axis D extends through the first connecting portion 352 and the drive surface 360. The threaded member 342 engages the base member 340 such that axial rotation of the threaded member 342 causes linear movement of the threaded member 342 relative to the base member 340. The handle 344 is arranged to facilitate axial rotation of the threaded member 342.

The receiving assembly 332 comprises a receiving member 370 and an adapter assembly 372. The example receiving member 370 defines an engaging surface 380, a second connecting portion 382, and a receiving cavity 384. The adapter assembly 372 defines third and fourth connecting portions 390 and 392 and an O-ring 394. The third connecting portion 390 is configured to engage the first connecting portion 352 to detachably attach the adapter member 372 to the base surface 350 of the base member 340. The second connecting portion 382 is configured to engage the fourth connecting portion 392 to detachably attach the receiving member 370 to the adapter member 372. Accordingly, with the receiving member 370 detachably attached to the adapter member 372 and the adapter member 372 detachably attached to the base member 340, the receiving member 370 is detachably attached to the base member 340. The O-ring 394 is sized, dimensioned, configured, and arranged to enhance a friction fit between the connecting portions 382 and 392.

In use, the receiving assembly 332 is detachably attached to the base member 340 using the first, second, third, and fourth connecting portions 352, 382, 390, and 392. In the example linear drive system 330, the first connecting portion 352 is formed by a threaded cavity and the third connecting portion 390 is formed by a threaded projection complementary to the threaded cavity forming the first connecting portion 352. Alternatively, the first and third connecting portions 352 and 390 may be formed by complementary square drives (one male, one female). Also in this example, the second connecting portion 382 is formed by a female square drive. The example receiving member 370 may thus be formed by standard socket drives for a socket wrench. A set of relatively inexpensive, off-the-shelf socket drives allows the user to adapt the third example press tool 320 to accommodate a wide variety of sizes, shapes, and configurations of universal joints in addition to the example universal joint 122.

Assembled as described above, the third example press tool 320 may then be used to disassemble and/or reassemble a universal joint such as the example universal joint 122.

The third example press tool 320 may thus be used in the same general manner as the first and second example press tools 120 and 220 to disassemble a universal joint such as the example universal joint 122. By reversing that process, the third example press tool 320 may, like the example press tools 120 and 220, also be used to reassemble the universal joint 122.

### IV. Fourth Example U-Joint Tool

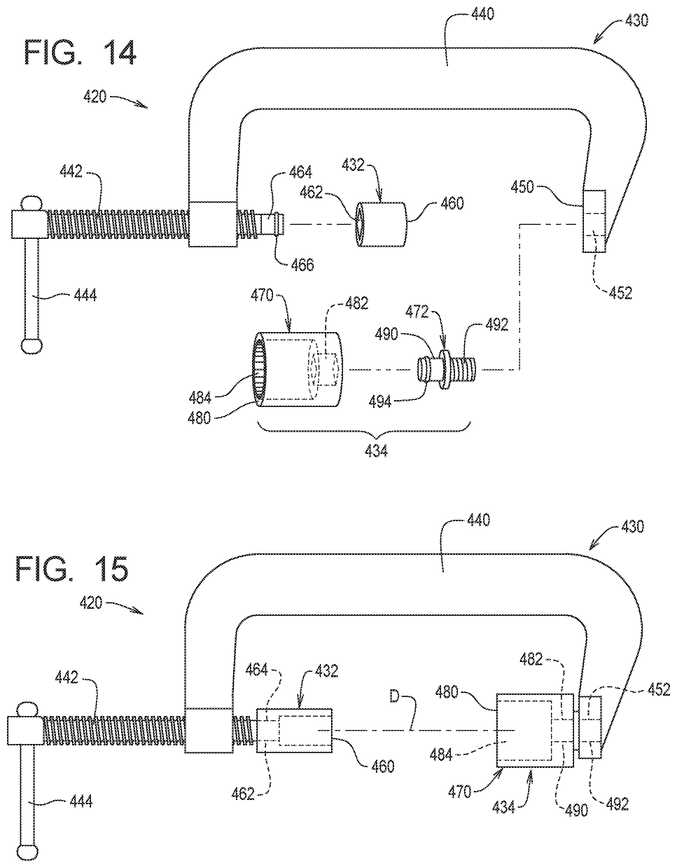

Referring now to FIGS. 14 and 15 of the drawing, depicted therein is a fourth example press tool 420 constructed in accordance with, and embodying, the principles of the present invention. The fourth example press tool 420 comprises a linear drive system 430, a drive member 432, and a receiving assembly 434.

The example linear drive system 430 comprises a base member 440, a threaded member 442, and a handle 444. Except for as noted below, the example linear drive system 430 may be constructed and operated in manner similar to that of a conventional C-clamp and is typically not directly supported by a work surface. The base member 440 defines a base surface 450 and a first connecting portion 452. The example first connecting portion 452 is integrally formed with the base member 440 but may be detachably attached thereto. The threaded member 442 engages the base member 440 such that axial rotation of the threaded member 442 causes linear movement of the threaded member 442 relative to the base member 440. The handle 444 is arranged to facilitate axial rotation of the threaded member 442.

The drive member 432 defines a drive surface 460 and a first drive connecting portion 462. A second drive connecting portion 464 is formed on the end of the threaded member 442. An O-ring 466 is arranged on the second drive connecting portion 464. The first and second drive connecting portions 462 and 464 are configured to allow the drive member 432 to be detachably attached to the threaded member 442. The O-ring 466 is sized, dimensioned, configured, and arranged to enhance a friction fit between the connecting portions 462 and 464. A drive axis D extends through the first connecting portion 452 and the drive surface 460 when the drive member 432 is detachably attached to the threaded member 442.

The receiving assembly 434 comprises a receiving member 470 and an adapter assembly 372. The receiving member 470 defines an engaging surface 480, a second connecting portion 482, and a receiving cavity 484. The adapter assembly 472 defines third and fourth connecting portions 490 and 492 and comprises an O-ring 494 arranged on the connecting portion 490. The fourth connecting portion 492 is configured to engage the first connecting portion 452 to detachably attach the adapter member 472 to the base surface 450 of the base member 440. The O-ring 494 is sized, dimensioned, configured, and arranged to enhance a friction fit between the connecting portions 482 and 490. The second connecting portion 482 is configured to engage the third connecting portion 490 to detachably attach the receiving member 470 to the adapter member 472. Accordingly, with the receiving member 470 detachably attached to the adapter member 472 and the adapter member 472 detachably attached to the base member 440, the receiving member 470 is detachably attached to the base member 440.

In use, the receiving assembly 434 is detachably attached to the base member 440 using the first, second, third, and fourth connecting portions 452, 482, 490, and 492. In the example linear drive system 430, the first connecting portion 452 is formed by a threaded cavity and the fourth connecting portion 492 is formed by a threaded projection complementary to the threaded cavity forming the first connecting portion 452. Alternatively, the first and fourth connecting portions 452 and 492 may be formed by complementary square drives (one male, one female). The example receiving member 470 may be formed by standard socket drives for a socket wrench defining a female square drive. A set of relatively inexpensive, off-the-shelf socket drives allows the user to adapt the fourth example press tool 420 to accommodate a wide variety of sizes, shapes, and configurations of universal joints in addition to the example universal joint 122.

The receiving member 470 is selected so that the receiving cavity 484 is capable of receiving (e.g., larger diameter than) a first bushing and the drive surface 460 of the drive member 432 is capable of applying a driving force to a second bushing of the example universal joint 122.

Assembled as described above, the fourth example press tool 420 may thus be used to disassemble a universal joint such as the example universal joint 122. By reversing that process, the fourth example press tool 420 may also be used to reassemble the universal joint 122.

### V. Fifth Example U-Joint Tool

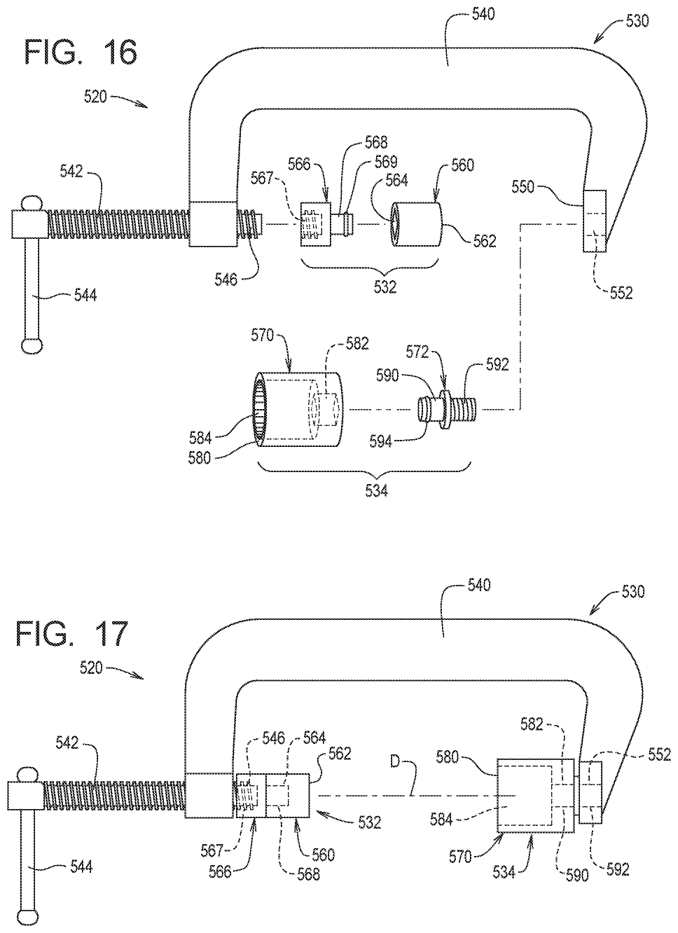

Referring now to FIGS. 16 and 17 of the drawing, depicted therein is a fifth example press tool 520 constructed in accordance with, and embodying, the principles of the present invention. The fifth example press tool 520 comprises a linear drive system 530, a drive assembly 532, and a receiving assembly 534. The fifth example press tool 520 may be used to disassemble the example universal joint 122 described above.

The example linear drive system 530 comprises a base member 540, a threaded member 542, and a handle 544. A first drive connecting portion 546 is formed on the threaded member 542. Except for as noted below, the example linear drive system 530 may be constructed and operated in manner similar to that of a conventional C-clamp and is typically not directly supported by a work surface. The base member 540 defines a base surface 550 and a first connecting portion 552. The example first connecting portion 552 is integrally formed with the base member 540 but may be detachably attached thereto. The threaded member 542 engages the base member 540 such that axial rotation of the threaded member 542 causes linear movement of the threaded member 542 relative to the base member 540. The handle 544 is arranged to facilitate axial rotation of the threaded member 542.

The drive assembly 532 comprises a drive member 560 defining a drive surface 562 and a second drive connecting portion 564 and a drive adapter 566 defining third and fourth drive connecting portions 567 and 568 and comprising an O-ring 569. The first and third drive connecting portions 546 and 567 are configured to allow the drive adapter 566 to be detachably attached to the threaded member 542. The second and fourth drive connector portions 564 and 568 are configured to allow the drive member 560 to be detachably attached to the drive adapter 566. The example first and third drive connecting portions 546 and 567 are formed by a threaded cavity and complementary threaded projection, but other connecting systems such as a square drive may also be used. A drive axis D extends through the first connecting portion 552 and the drive surface 562 when the drive assembly 532 is detachably attached to the threaded member 542.

The receiving assembly 534 comprises a receiving member 570 and an adapter assembly 572. The receiving member 570 defines an engaging surface 580, a second connecting portion 582, and a receiving cavity 584. The adapter assembly 572 defines third and fourth connecting portions 590 and 592 and comprises an O-ring 594. The fourth connecting portion 592 is configured to engage the first connecting portion 552 to detachably attach the adapter member 572 to the base surface 550 of the base member 540. The second connecting portion 582 is configured to engage the third connecting portion 590 to detachably attach the receiving member 570 to the adapter member 572. Accordingly, with the receiving member 570 detachably attached to the adapter member 572 and the adapter member 572 detachably attached to the base member 540, the receiving member 570 is detachably attached to the base member 540.

In use, the receiving assembly 534 is detachably attached to the base member 540 using the first, second, third, and fourth connecting portions 552, 582, 590, and 592. In the example linear drive system 530, the first connecting portion 552 is formed by a threaded cavity and the fourth connecting portion 592 is formed by a threaded projection complementary to the threaded cavity forming the first connecting portion 552. Alternatively, the first and third connecting portions 552 and 592 may be formed by complementary square drives (one male, one female). Also in this example, the second connecting portion 582 is formed by a female square drive and the third connecting portion 590 may be formed by a male square drive.

In the fifth example press tool 520, the example drive member 560 and receiving member 570 may be formed by standard socket drives for a socket wrench. A set of relatively inexpensive, off-the-shelf socket drives allows the user to adapt the fifth example press tool 520 to accommodate a wide variety of sizes, shapes, and configurations of universal joints in addition to the example universal joint 122.

The O-rings 569 and 594 are sized, dimensioned, configured, and arranged to enhance a friction fit and thus hold the drive member 560 and and receiving member 570 in place when the example press tool 520 is in the assembled configuration to prevent inadvertent removal of the drive member 560 and/or receiving member 570 prior to use of the first example press tool 520.

Assembled as described above, the fifth example press tool 520 may then be used to disassemble and/or reassemble a universal joint such as the example universal joint 122. By reversing that process, the fifth example press tool 520 may also be used to reassemble the universal joint 122.

### VI. Alternative Example U-Joint Tool

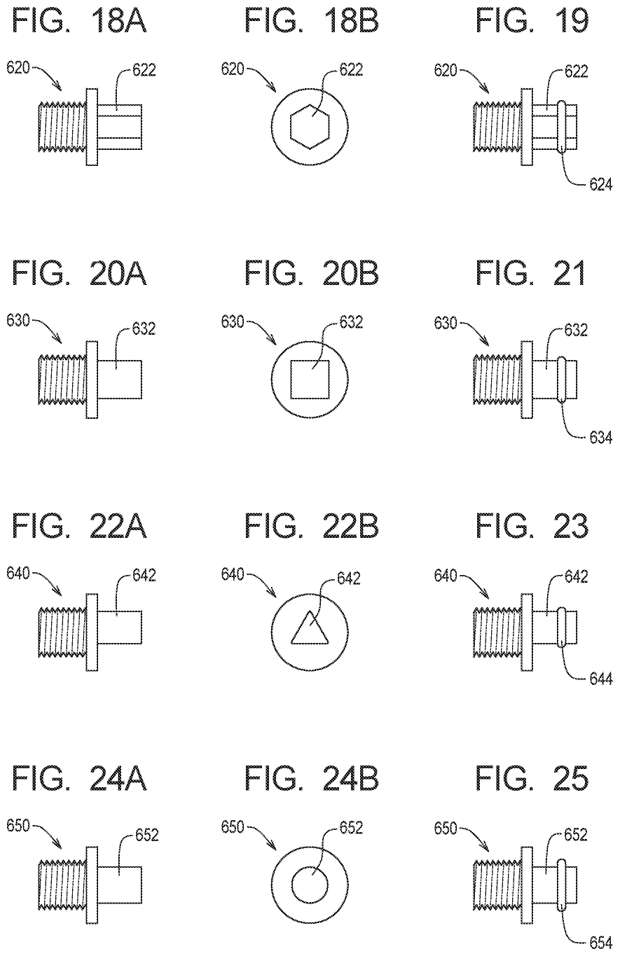

FIGS. 18A, 18B, and 19 illustrate a first alternative connecting member 620 that may be used in addition to or instead of the connecting portions described above. The first example alternative connecting member 620 defines a hex post 622 and an O-ring 624 sized, dimensioned, configured, and arranged to enhance a friction fit between the hex post 622 and a square drive cavity defined by a standard socket drive.

FIGS. 20A, 20B, and 21 illustrate a second alternative connecting member 630 that may be used in addition to or instead of the connecting portions described above. The second example alternative connecting member 620 defines a square post 632 and an O-ring 634 sized, dimensioned, configured, and arranged to enhance a friction fit between the square post 632 and a square drive cavity defined by a standard socket drive.

FIGS. 22A, 22B, and 23 illustrate a third alternative connecting member 640 that may be used in addition to or instead of the connecting portions described above. The third example alternative connecting member 640 defines a triangular post 642 and an O-ring 644 sized, dimensioned, configured, and arranged to enhance a friction fit between the triangular post 642 and a square drive cavity defined by a standard socket drive.

FIGS. 24A, 24B, and 25 illustrate a fourth alternative connecting member 650 that may be used in addition to or instead of the connecting portions described above. The third example alternative connecting member 650 defines a cylindrical post 652 and an O-ring 654 sized, dimensioned, configured, and arranged to enhance a friction fit between the cylindrical post 652 and a square drive cavity defined by a standard socket drive.

The example connecting members 620, 630, 640, and 650 all define, in addition to the posts 622, 632, 642, and 652, an externally threaded portion adapted to engage a linear drive system. As one alternative, the externally threaded portions may be replaced by internally threaded portions. In addition, alternative connecting systems such as a standard square drive connector may be used. The connecting members 620, 630, 640, and 650 may also be integrally formed with the drive system supporting the connecting members 620, 630, 640, and 650.

The example posts 622, 632, 642, and 652 of the example connecting members 620, 630, 640, and 650 do not employ a groove or projection to maintain the O-rings in place. Alternatively, one or more of a continuous groove, discontinuous notches, projections, adhesives, or the like may be provided to inhibit movement of the O-rings relative to the posts 622, 632, 642, and 652.

### VII. Additional Considerations

The example linear drive systems described above are all hand-operated mechanical devices employing a threaded rod. Alternatively, hand-operated levers and/or cams or hydraulic or pneumatic pistons may be used as the linear drive system of the present invention. Additionally, the present invention may include a powered linear drive system capable of developing the forces necessary to disassemble a universal joint. Other examples of suitable powered linear drive systems include hydraulic or pneumatic pistons. Accordingly, electric, hydraulic, or pneumatic drive systems may be used to rotate a threaded member or displace a piston to develop a linear drive motion.

What is claimed is:

1. A press tool for using a plurality of socket drives each defining a square drive cavity, a socket cavity, and a socket perimeter surface extending around the socket cavity to displace a first part relative to a second part, the press tool comprising:
a drive system defining first and second drive portions, where the drive system is configured to allow at least one the first and second drive portions to be displaced relative to at least one of the first and second drive portions along a drive axis;
a first drive projection supported by the first drive portion; and
a first friction member; whereby
the first drive projection is adapted to be received at least partly within the square drive cavity of a first selected socket drive of the plurality of socket drives to allow the first selected drive socket to be detachably attached to the first drive portion such that
the socket cavity of a first selected drive socket selected from the plurality of socket drives defines a receiving cavity, and
the socket perimeter surface of the first selected drive socket defines an engaging surface;
the first friction member is arranged between the first drive projection and the square drive cavity of the first selected socket drive to enhance friction between the first drive projection and the first selected drive socket.

2. A press tool as recited in claim 1, further comprising:
a second drive projection; and
a second friction member; whereby
the second drive projection is adapted to be received at least partly within the square drive cavity of a second selected socket drive of the plurality of socket drives to allow the second selected drive socket to be detachably attached to the second drive portion such that
the socket cavity of a second selected drive socket selected from the plurality of socket drives defines a receiving cavity, and
the socket perimeter surface of the second selected drive socket defines an engaging surface;
the second friction member is arranged between the second drive projection and the square drive cavity of the second selected socket drive to enhance friction between the second drive projection and the second selected drive socket.

3. A method of using a plurality of socket drives each defining a square drive cavity, a socket cavity, and a socket perimeter surface extending around the socket cavity to displace a first part relative to a second part, the method comprising the steps of:
providing a drive system defining first and second drive portions, where the drive system is configured to allow at least one the first and second drive portions to be displaced relative to at least one of the first and second drive portions along a drive axis;
supporting a first drive projection with the first drive portion;
providing a first friction member;
arranging the first drive projection at least partly within the square drive cavity of a first selected socket drive of the plurality of socket drives to allow the first selected drive socket to be detachably attached to the first drive portion such that
the socket cavity of a first selected drive socket selected from the plurality of socket drives defines a receiving cavity, and
the socket perimeter surface of the first selected drive socket defines an engaging surface;
arranging the first friction member between the first drive projection and the square drive cavity of the first selected socket drive to enhance friction between the first drive projection and the first selected drive socket.

4. A method as recited in claim 3, further comprising the steps of:
providing a second drive projection; and
providing a second friction member; whereby
arranging the second drive projection at least partly within the square drive cavity of a second selected socket drive of the plurality of socket drives to allow the second selected drive socket to be detachably attached to the second drive portion such that
the socket cavity of a second selected drive socket selected from the plurality of socket drives defines a receiving cavity, and
the socket perimeter surface of the second selected drive socket defines an engaging surface;
arranging the second friction member between the second drive projection and the square drive cavity of the second selected socket drive to enhance friction between the second drive projection and the second selected drive socket.

5. A press tool for using a plurality of socket drives each defining a square drive cavity, a socket cavity, and a socket perimeter surface extending around the socket cavity to displace a first part relative to a second part, the press tool comprising:
a drive system defining first and second drive portions, where the drive system is configured to allow at least one the first and second drive portions to be displaced relative to at least one of the first and second drive portions along a drive axis;
a first drive projection supported by the first drive portion; and
a first O-ring; whereby
the first drive projection is adapted to be received at least partly within the square drive cavity of a first selected socket drive of the plurality of socket drives to allow the first selected drive socket to be detachably attached to the first drive portion such that
the socket cavity of a first selected drive socket selected from the plurality of socket drives defines a receiving cavity, and
the socket perimeter surface of the first selected drive socket defines an engaging surface; and
the first O-ring is arranged between the first drive projection and the square drive cavity of the first selected socket drive to enhance friction between the first drive projection and the first selected drive socket.

6. A press tool as recited in claim 5, further comprising:
a second drive projection; and
a second O-ring; whereby
the second drive projection is adapted to be received at least partly within the square drive cavity of a second selected socket drive of the plurality of socket drives to allow the second selected drive socket to be detachably attached to the second drive portion such that
the socket cavity of a second selected drive socket selected from the plurality of socket drives defines a receiving cavity, and
the socket perimeter surface of the second selected drive socket defines an engaging surface; and
the second O-ring is arranged between the second drive projection and the square drive cavity of the second selected socket drive to enhance friction between the second drive projection and the second selected drive socket.
